(19) United States
(12) Patent Application Publication
(10) Pub. No.: US 2019/0144329 A1
(43) Pub. Date: May 16, 2019

(54) GLASS COMPOSITION, GLASS FIBERS, GLASS CLOTH, AND METHOD FOR PRODUCING GLASS FIBERS

(71) Applicants: NIPPON SHEET GLASS COMPANY, LIMITED, Tokyo (JP); UNITIKA LTD., Amagasaki-shi, Hyogo (JP); UNITIKA GLASS FIBER CO., LTD., Uji-shi, Kyoto (JP)

(72) Inventors: Yoshiyuki INAKA, Mie (JP); Takaharu MIYAZAKI, Kyoto (JP); Yoshito NAWA, Kyoto (JP); Daisuke NISHINAKA, Gifu (JP); Tomoki SEKIDA, Gifu (JP)

(73) Assignees: Nippon Sheet Glass Company, Limited, Tokyo (JP); Unitika Ltd., Amagasaki-shi, Hyogo (JP); Unitika Glass Fiber Co., Ltd., Uji-shi, Kyoto (JP)

(21) Appl. No.: 16/097,033

(22) PCT Filed: Nov. 1, 2016
(86) PCT No.: PCT/JP2016/004785

§ 371 Date: Oct. 26, 2018

(30) Foreign Application Priority Data
Apr. 28, 2016 (JP) 2016-089973

(51) Int. Cl. C03C 3/093; C03C 3/091; C03C 4/16; C03C 13/00; C03B 37/02; D03D 15/00; D03D 15/12

(52) U.S. Cl. CPC C03C 3/093; C03C 3/091; C03C 4/16; C03C 13/00; C03C 2204/00; D03D 15/0011; D03D 15/12; C03C 2213/00; C03B 37/02

(57) ABSTRACT

A glass composition of the present disclosure includes, in wt %, 50≤SiO₂≤54, 25≤B₂O₃≤30, 12≤Al₂O₃≤15, 0.5≤MgO≤1.9, 3.0≤CaO≤5.5, 0≤ZnO≤3.5, 0.1≤Li₂O≤0.5, and 0.1≤Na₂O≤0.3, and has a permittivity of less than 5.0 at a frequency of 1 MHz. The glass composition of the present disclosure has a low permittivity. The use of this glass composition can reduce the occurrence of devitrification and the inclusion of bubbles in glass fibers to be formed or in a shaped glass material to be formed even when the glass fibers have a small fiber diameter or the shaped glass material has a small thickness.

### TECHNICAL FIELD

The present invention relates to a glass composition, and glass fibers and a glass cloth composed of the composition. The present invention further relates to a method for producing glass fibers.

### BACKGROUND ART

Printed circuit boards mounted in electronic devices include a board composed of a resin, glass fibers, an inorganic filler, and other necessary materials such as a curing agent and a modifying agent. Printed wiring boards, which have no electronic components installed, may be composed in the same manner. In the following description, both printed circuit boards and printed wiring boards are collectively referred to as “printed boards”. In such a printed board, glass fibers function as an insulator, as a heat-resistant material, and as a reinforcement of the board. In some printed boards, glass fibers may be included in the form of a glass cloth, which is produced by weaving glass yarns each consisting of glass fibers bundled together. In recent years, printed boards have been made thinner to meet the demand for reducing the size of electronic devices and the demand for increasing the degree of integration of printed boards and thereby achieving high performance. To this end, glass fibers with a reduced fiber diameter are needed as glass fibers for use in printed boards. Furthermore, there is a rapidly increasing demand for high-speed transmission of large volumes of data and, accordingly, glass fibers for use in printed boards are required to have a low permittivity.

Glass may be used also as an inorganic filler for use in printed boards. Typical examples of the inorganic filler include glass flakes. When a shaped glass material, such as glass flakes, is used as an inorganic filler in a printed board, the shaped material is required to have the same properties, such as a low permittivity, as glass fibers used in the printed board. To adapt to the thickness reduction of printed boards, the shaped glass material must be a thinned material with a small thickness.

Glass fibers composed of a low-permittivity glass composition are disclosed, for example, in Patent Literatures 1 to 3. Patent Literature 2 states that the glass composition of this literature is substantially free of MgO, Li₂O, Na₂O, K₂O, and TiO₂ (see the claims and the paragraph 0008).

### CITATION LIST

### Patent Literature

Patent Literature 1: JP 62(1987)-226839 A
Patent Literature 2: JP 2010-508226 A
Patent Literature 3: JP 2009-286686 A

### SUMMARY OF INVENTION

### Technical Problem

When conventional low-permittivity glass compositions are formed into glass fibers by fiber forming process, the occurrence of devitrification cannot necessarily be reduced sufficiently. The devitrification is likely to occur especially when glass fibers having a small fiber diameter are formed or when a glass composition is formed into shaped pieces such as marbles or rods and then the shaped pieces are remelted and formed into glass fibers (in a typical example, glass fibers are produced by a marble melt process). Studies by the present inventors have revealed that fine crystals (devitrification) have a large impact on forming of glass fibers having a small fiber diameter, although similar fine crystals may, when glass fibers as disclosed in Patent Literature 1 which have a relatively large fiber diameter (a fiber diameter of 8 to 13 μm) are formed, have no impact on the strength of the glass fibers and cause no fiber breakage during the fiber forming. One possible reason for this is that forming of glass fibers having a small fiber diameter requires reducing the drawing rate of molten glass and hence involves allowing the glass composition to lie in a devitrification temperature range for a long period of time. Another possible reason is that in fiber forming by a remelt process, the glass composition inevitably goes through a devitrification temperature range during remelting. As for the reduction in drawing rate, specifically, the ratio of the drawing rate in forming of glass fibers having an average fiber diameter of 3 μm to the drawing rate in forming of glass fibers having an average fiber diameter of 9 μm is as large as 3²/9².

Additionally, the inclusion of bubbles in glass fibers, in particular glass fibers for use in printed boards, is desirably reduced as much as possible. For example, glass fibers including devitrification (devitrified regions) and/or bubbles are likely to suffer fiber breakage. The fiber breakage diminishes the efficiency of production of glass fibers. Even if glass fibers have been produced, a high degree of devitrification remaining in the fibers and/or a large amount of bubbles remaining in the fibers can inhibit the fibers from providing sufficient properties when the fibers are used, for example, in printed boards. In a specific example where glass fibers including bubbles are used as hollow fibers in a printed board, a metal used for formation of through holes enters the inside of the fibers, and this entry of the metal causes poor electrical conduction, leading to a significant decrease in reliability of the printed board. The occurrence of devitrification and the inclusion of bubbles in glass fibers, in particular glass fibers for use in printed boards, should be avoided as much as possible.

The discussion given above for glass fibers applies also to thin shaped glass materials such as glass flakes which have a small thickness. In particular, in the case of a thin shaped glass material for use in printed boards, the occurrence of devitrification and the inclusion of bubbles should be avoided as much as possible. Specifically, glass flakes are produced, for example, by a blow process disclosed in WO 2012/026127 A1. In the blow process, a glass balloon is formed from molten glass, and the glass balloon formed is crushed into glass flakes. Fine crystals (devitrification) which may cause no problem in formation of a relatively thick-walled balloon can have a large impact on formation of a thin-walled balloon and give rise to balloon fracture which precludes the production of glass flakes. In formation of a thin-walled balloon, as in forming of glass fibers having a small fiber diameter, the drawing rate of molten glass is so low that devitrification is likely to occur, in addition to which remelting for balloon formation is likely to cause devitrification. The inclusion of bubbles in molten glass leads to balloon fracture which precludes the production of glass flakes. Even if glass flakes have been produced, a high degree of devitrification remaining in the glass flakes and/or a large amount of bubbles remaining in the glass flakes can inhibit the glass flakes from exhibiting sufficient properties when the glass flakes are used, for example, in printed boards.

It is an object of the present invention to provide a low-permittivity glass composition with which the occurrence of devitrification and the inclusion of bubbles in glass fibers to be formed or in a shaped glass material to be formed can be reduced even when the glass fibers have a small fiber diameter or the shaped glass material has a small thickness.

### Solution to Problem

The glass composition of the present invention is a glass composition including, in wt %: 50≤SiO₂≤54; 25≤B₂O₃≤30; 12≤Al₂O₃≤15; 0.5≤MgO≤1.9; 3.0≤CaO≤5.5; 0≤ZnO≤3.5, 0.1≤Li₂O≤0.5; and 0.1≤Na₂O≤0.3, the glass composition having a permittivity of less than 5.0 at a frequency of 1 MHz.

Glass fibers of the present invention include the above glass composition of the present invention.

A glass cloth of the present invention includes the above glass fibers of the present invention.

A method for producing glass fibers according to the present invention includes melting the above glass composition of the present invention at a temperature of 1400° C. or higher, wherein glass fibers having an average fiber diameter of 3 to 6 μm are obtained.

### Advantageous Effects of Invention

According to the present invention, it is possible to obtain a low-permittivity glass composition with which the occurrence of devitrification and the inclusion of bubbles in glass fibers to be formed or in a shaped glass material to be formed can be reduced even when the glass fibers have a small fiber diameter or the shaped glass material has a small thickness.

### DESCRIPTION OF EMBODIMENTS

[Glass Composition]

The glass composition of the present invention is a glass composition including, in wt %:

50≤SiO₂≤54;

25≤B₂O₃≤30;

12≤Al₂O₃≤15;

0.5≤MgO≤1.9;

3.0≤CaO≤5.5;

0≤ZnO≤3.5;

0.1≤Li₂O≤0.5; and

0.1≤Na₂O≤0.3,

the glass composition having a permittivity of less than 5.0 at a frequency of 1 MHz.

The term “permittivity” refers, in a strict sense, to a relative permittivity expressed as a ratio relative to the permittivity of vacuum. In the present specification, the relative permittivity is simply referred to as “permittivity” as is conventional. The values of permittivity in the present specification are those determined at room temperature (25° C.).

For the glass composition of the present invention, the reason for limiting the components and their proportions will be described. In the following description, the symbol “%” used to indicate the proportions of the components means “wt %” in every case. The following description takes glass fibers as an example. It should be understood that the same description applies to shaped glass materials such as glass flakes. For example, “glass having a small fiber diameter” corresponds to “shaped glass material having a small thickness”, in particular to “glass flakes having a small thickness”.

(SiO₂)

SiO₂ is an essential component for forming a network structure of glass. SiO₂ acts to lower the permittivity. If the content of SiO₂ is less than 50%, it is difficult to control the permittivity of the glass composition at a frequency of 1 MHz to less than 5.0. If the content exceeds 54%, the viscosity at melting is increased, so that it is difficult to make the glass composition homogeneous in production of glass fibers. This trend is significant especially in the case of a direct melt process. Not only the occurrence of devitrification and the inclusion of bubbles but also poor homogeneity of the glass composition can cause breakage of glass fibers, in particular glass fibers having a small fiber diameter, and the poor homogeneity leads to a failure to obtain sufficient properties as glass fibers. The poor homogeneity at melting causes the molten glass to partially have a composition susceptible to devitrification or a composition yielding high viscosity and poor defoaming performance. Additionally, if the content exceeds 54%, the increase in viscosity at melting causes a deterioration in defoaming performance (bubble removability) of the molten glass and hence insufficient reduction of the inclusion of bubbles in the glass fibers formed, thus giving rise to breakage of the glass fibers, in particular those having a small fiber diameter. For these reasons, the content of SiO₂ is 50% or more and 54% or less.

(B₂O₃)

B₂O₃ is an essential component for forming a network structure of glass. B₂O₃ acts to lower the permittivity and further acts to lower the viscosity of the glass composition at melting, improve the defoaming performance (bubble removability), and reduce the inclusion of bubbles in the glass fibers formed. However, since B₂O₃ may volatilize during melting of the glass composition, an excessively high content of B₂O₃ makes it difficult to make the glass composition homogeneous in production of glass fibers. If the content of B₂O₃ is less than 25%, it is difficult to control the permittivity of the glass composition at a frequency of 1 MHz to less than 5.0 and, in addition, the viscosity of the glass composition at melting is increased, so that the glass composition fails to attain sufficient homogeneity and that the inclusion of bubbles in the glass fibers formed cannot be reduced sufficiently. If the content exceeds 30%, B₂O₃ may volatilize during melting of the glass composition and, in this case, the glass composition fails to attain sufficient homogeneity. In regions from which B₂O₃ has volatilized, the contents of SiO₂ and Al₂O₃ become relatively high and, in particular, a region where the increase in the content of Al₂O₃ is significant becomes more likely to suffer devitrification. Additionally, if the content of B₂O₃ exceeds 30%, the glass composition becomes more likely to undergo phase separation, which decreases the chemical resistance of the glass composition. When glass fibers are used in a printed board, in particular when glass fibers having a small fiber diameter are used in a printed board, it is desirable for the glass fibers to have high chemical resistance. In view of these facts, the upper limit of the content of B₂O₃ is preferably 29.5% or less, more preferably 29% or less, even more preferably 28.5% or less, and particularly preferably 28% or less. That is, the content of B₂O₃ can be 25% or more and 29.5% or less, can be 25% or more and 29% or less, can be 25% or more and 28.5% or less, and can be 25% or more and 28% or less. Depending on the balance with respect to the contents of the other components, the lower limit of the content of B₂O₃ can be 25% or more and can be more than 25%.

(Al₂O₃)

Al₂O₃ is an essential component for forming a network structure of glass. Al₂O₃ acts to increase the chemical resistance of the glass composition. However, the presence of Al₂O₃ increases the viscosity of the glass composition at melting and makes the glass composition more likely to suffer devitrification during fiber forming. If the content of Al₂O₃ is less than 12%, the chemical resistance of the glass composition is decreased. Additionally, if the content is less than 12%, increases in the contents of SiO₂ and B₂O₃ which are the other network-forming components, in particular an increase in the content of SiO₂, are necessitated, and thus the viscosity of the glass composition at melting is increased, so that the glass composition fails to attain sufficient homogeneity and that the inclusion of bubbles in the glass fibers formed cannot be reduced sufficiently. If the content of Al₂O₃ exceeds 15%, the contents of SiO₂ and B₂O₃ which are the other network-forming components are decreased and thus the permittivity of the glass composition is increased, so that it is difficult to control the permittivity at a frequency of 1 MHz to less than 5.0. Additionally, if the content of Al₂O₃ exceeds 15%, the viscosity of the glass composition at melting is increased, so that the glass composition fails to attain sufficient homogeneity and that the inclusion of bubbles in the glass fibers formed cannot be reduced sufficiently. Furthermore, the glass composition becomes more likely to suffer devitrification.

(MgO)

MgO is an essential component that acts to improve the meltability of glass raw materials and lower the viscosity of the glass composition at melting. However, the presence of MgO increases the permittivity of the glass composition. If the content of MgO is less than 0.5%, the viscosity of the glass composition at melting is increased, so that the glass composition fails to attain sufficient homogeneity and that the inclusion of bubbles in the glass fibers formed cannot be reduced sufficiently. If the content exceeds 1.9%, the permittivity of the glass composition is increased, and it is difficult to control the permittivity at a frequency of 1 MHz to less than 5.0. In view of these facts, the upper limit of the content of MgO is preferably 1.8% or less, more preferably 1.7% or less, even more preferably 1.6% or less, and particularly preferably 1.5% or less. That is, the content of MgO can be 0.5% or more and 1.8% or less, can be 0.5% or more and 1.7% or less, can be 0.5% or more and 1.6% or less, and can be 0.5% or more and 1.5% or less. Depending on the balance with respect to the other components, the lower limit of the content of MgO can be 1.5% or more and can be more than 1.5%.

(CaO)

CaO is an essential component that, like MgO and ZnO, acts to improve the meltability of glass raw materials and lower the viscosity of the glass composition at melting. This action of CaO is more significant than that of MgO and ZnO. However, the presence of CaO increases the permittivity of the glass composition. If the content of CaO is less than 3.0%, the viscosity of the glass composition at melting is increased, so that the glass composition fails to attain sufficient homogeneity and that the inclusion of bubbles in the glass fibers formed cannot be reduced sufficiently. If the content is less than 3.0%, the glass composition is likely to undergo phase separation. If the content exceeds 5.5%, the permittivity of the glass composition is increased, and it is difficult to control the permittivity at a frequency of 1 MHz to less than 5.0. Nevertheless, CaO causes a smaller increase in dielectric loss tangent of the glass composition than MgO and ZnO.

(ZnO)

ZnO is an optional component that acts to improve the meltability of glass raw materials and lower the viscosity of the glass composition at melting. However, the presence of ZnO increases the permittivity of the glass composition. If the content of ZnO exceeds 3.5%, the permittivity of the glass composition is increased, and it is difficult to control the permittivity at a frequency of 1 MHz to less than 5.0. The lower limit of the content of ZnO is preferably 1.5% and, in this case, the increase in viscosity of the glass composition at melting is controlled, so that the glass composition can attain improved homogeneity and that the inclusion of bubbles in the glass fibers formed can be further reduced. Depending on the balance with respect to the other components, the upper limit of the content of ZnO can be 1.5% or less, can be less than 1.5%, and can even be 1.0% or less. The glass composition may be substantially free of ZnO.

(CaO/(MgO+CaO+ZnO))

For MgO, CaO, and ZnO, the ratio of the content of CaO to the sum of the contents of the three components (MgO+CaO+ZnO), namely the ratio CaO/(MgO+CaO+ZnO), is preferably 0.31 to 0.63 and more preferably 0.50 to 0.63. Increasing the content of CaO increases the permittivity of the glass composition; however, when the above ratio is in the specified range, the degree of increment in permittivity of the glass composition can be reduced.

(Li₂O)

Li₂O is an essential component that acts to improve the meltability of glass raw materials and lower the viscosity of the glass composition at melting. However, the presence of Li₂O increases the permittivity and dielectric loss tangent of the glass composition. If the content of Li₂O is less than 0.1%, the viscosity of the glass composition at melting is increased, so that the glass composition fails to attain sufficient homogeneity and that the inclusion of bubbles in the glass fibers formed cannot be reduced sufficiently. If the content exceeds 0.5%, the permittivity of the glass composition is increased, and it is difficult to control the permittivity at a frequency of 1 MHz to less than 5.0.

(Na₂O)

Na₂O is an essential component that, like Li₂O, acts to improve the meltability of glass raw materials and lower the viscosity of the glass composition at melting. However, the presence of Na₂O increases the permittivity and dielectric loss tangent of the glass composition. If the content of Na₂O is less than 0.1%, the viscosity of the glass composition at melting is increased, so that the glass composition fails to attain sufficient homogeneity and that the inclusion of bubbles in the glass fibers formed cannot be reduced sufficiently. If the content exceeds 0.3%, the permittivity of the glass composition is increased, and it is difficult to control the permittivity at a frequency of 1 MHz to less than 5.0.

(Balance Among Network-Forming Components)

In the glass composition of the present invention, a balance exists among the contents of the various components described above. Such a balance can give the glass composition a low permittivity and reduce the occurrence of devitrification and the inclusion of bubbles in glass fibers to be formed or in a shaped glass material to be formed even when the glass fibers have a small fiber diameter or the shaped glass material has a small thickness. For SiO₂, B₂O₃, and Al₂O₃ which are network-forming components, the following balance is established among the contents in wt % of these components: 50≤SiO₂≤54, 25≤B₂O₃≤30, and 12≤Al₂O₃≤15.

In an embodiment, for the balance among the network-forming components, the contents in wt % of B₂O₃ and Al₂O₃ more preferably satisfy 25≤B₂O₃≤27 and 14≤Al₂O₃≤15. In this case, the inclusion of bubbles in the glass fibers formed can be further reduced.

In an embodiment, for the balance among the network-forming components, the content in wt % of B₂O₃ more preferably satisfies 25≤B₂O₃≤26.6. In this case, it is even more preferable that the content in wt % of Al₂O₃ satisfy 14≤Al₂O₃≤15. In these cases, the inclusion of bubbles in the glass fibers formed can be further reduced.

In an embodiment, for the balance among the network-forming components, the content in wt % of SiO₂ more preferably satisfies 50≤SiO₂≤52.5. In this case, it is even more preferable that the content(s) of B₂O₃ and/or Al₂O₃ be in the preferred range(s) previously described. In these cases, the inclusion of bubbles in the glass fibers formed can be further reduced.

(Balance Among Modifying Components)

In the glass composition of the present invention, not only is established the above balance among the contents of the network-forming components while the contents of these components are in the previously-described ranges including preferred ranges, but also the following balance is established among the contents in wt % of MgO, CaO, ZnO, Li₂O, and Na₂O which are modifying components contained in addition to the network-forming components: 0.5≤MgO≤1.9, 3.0≤CaO≤5.5, 0≤ZnO≤3.5, 0.1≤Li₂O≤0.5, and 0.1≤Na₂O≤0.3.

In an embodiment, for the balance among the modifying components, the content in wt % of MgO more preferably satisfies 0.5≤MgO≤1.3 and even more preferably satisfies 0.5≤MgO≤1.0. In this case, the inclusion of bubbles in the glass fibers formed can be further reduced.

In an embodiment, for the balance among the modifying components, not only the content of MgO but also the contents of Li₂O and Na₂O may be specifically limited. That is, it is more preferable that the content in wt % of MgO satisfy 1.2≤MgO≤1.5 and the total content in wt % of Li₂O and Na₂O satisfy 0.4≤Li₂O+Na₂O≤0.8. Also in this case, the inclusion of bubbles in the glass fibers formed can be further reduced.

For the balance among the modifying components, the content of ZnO may in particular be controlled. In an embodiment, the content in wt % of ZnO more preferably satisfies 1.5≤ZnO≤3.5. Also in this case, the inclusion of bubbles in the glass fibers formed can be further reduced.

Rendering the glass composition substantially free of ZnO can also result in further reduction of the inclusion of bubbles in the glass fibers formed. Specifically, in an embodiment, the glass composition may be a glass composition that is substantially free of ZnO and in which the content in wt % of MgO satisfies 1.2≤MgO≤1.9, more preferably satisfies 1.2≤MgO≤1.5, and even more preferably satisfies 1.3≤MgO≤1.5. In these cases, it is even more preferable that the total content of MgO and CaO be 5.5% or more.

The glass composition of the present invention may contain the components described hereinafter as long as the effect of the present invention is obtained.

(Additional Components)

The glass composition of the present invention may contain, as an additional component, at least one selected from ZrO₂, Fe₂O₃, SO₂, La₂O₃, WO₃, Nb₂O₅, Y₂O₃, and MoO₃, provided that the content of each of these components is 0% or more and 1% or less.

The glass composition of the present invention may contain, as an additive, at least one selected from SnO₂, As₂O₃, and Sb₂O₃, provided that the content of each of these additives is 0% or more and 1% or less.

The glass composition of the present invention may contain, as additional components, Cr₂O₃, H₂O, OH, H₂, CO₂, CO, He, Ne, Ar, and N₂, provided that the content of each of these components is 0% or more and 0.1% or less.

The glass composition of the present invention may contain a trace amount of noble metal elements. For example, the glass composition may contain noble metal elements such as Pt, Rh, and Os, provided that the content of each of these noble metal elements is 0% or more and 0.1% or less.

The glass composition of the present invention may consist essentially of the components described above. In this case, the contents of the components in the glass composition and the balance among the contents of the components can satisfy the numerical ranges described above, including the preferred ranges. The term “consist essentially of” as used herein is intended to mean that impurities such as those derived from the glass raw materials, the apparatus for producing the glass composition, and the apparatus for shaping the glass composition may be contained in an amount of less than 0.1%.

An example of such a glass composition is a glass composition consisting essentially of, in wt %, 50≤SiO₂≤54, 25≤B₂O₃≤30, 12≤Al₂O₃≤15, 0.5≤MgO≤1.9, 3.0≤CaO≤5.5, 0≤ZnO≤3.5, 0.1≤Li₂O≤0.5, and 0.1≤Na₂O≤0.3, the glass composition having a permittivity of less than 5.0 at a frequency of 1 MHz.

In another example, the glass composition can be a glass composition consisting essentially of, in wt %, 50.0≤SiO₂≤54.0, 25.0≤B₂O₃≤30.0, 12.0≤Al₂O₃≤15.0, 0.50≤MgO≤1.90, 3.00≤CaO≤5.50, 0≤ZnO≤3.50, 0.10≤Li₂O≤0.50, and 0.10≤Na₂O≤0.30, the glass composition having a permittivity of less than 5.0 at a frequency of 1 MHz.

In still another example, the glass composition can be a glass composition consisting essentially of, in wt %, 50.0≤SiO₂≤54.0, 25.0≤B₂O₃≤28.0, 12.0≤Al₂O₃≤15.0, 0.50≤MgO≤1.50, 3.00≤CaO≤5.50, 0≤ZnO≤3.50, 0.10≤Li₂O≤0.50, and 0.10≤Na₂O≤0.30, the glass composition having a permittivity of less than 5.0 at a frequency of 1 MHz.

In still another example, the glass composition can be a glass composition consisting essentially of, in wt %, 50.0≤SiO₂≤54.0, 28.1≤B₂O₃≤30.0, 12.0≤Al₂O₃≤15.0, 0.50≤MgO≤1.90, 3.00≤CaO≤5.50, 0≤ZnO≤3.50, 0.10≤Li₂O≤0.50, and 0.10≤Na₂O≤0.30, the glass composition having a permittivity of less than 5.0 at a frequency of 1 MHz.

In still another example, the glass composition can be a glass composition consisting essentially of, in wt %, 50.0≤SiO₂≤54.0, 25.0≤B₂O₃≤30.0, 12.0≤Al₂O₃≤15.0, 1.51≤MgO≤1.90, 3.00≤CaO≤5.50, 0≤ZnO≤3.50, 0.10≤Li₂O≤0.50, and 0.10≤Na₂O≤0.30, the glass composition having a permittivity of less than 5.0 at a frequency of 1 MHz.

In still another example, the glass composition can be a glass composition consisting essentially of, in wt %, 50.0≤SiO₂≤54.0, 28.1≤B₂O₃≤30.0, 12.0≤Al₂O₃≤15.0, 1.51≤MgO≤1.90, 3.00≤CaO≤5.50, 0≤ZnO≤3.50, 0.10≤Li₂O≤0.50, and 0.10≤Na₂O≤0.30, the glass composition having a permittivity of less than 5.0 at a frequency of 1 MHz.

In still another example, the glass composition can be a glass composition consisting essentially of, in wt %, 50.0≤SiO₂≤54.0, 26.0≤B₂O₃≤30.0, 12.0≤Al₂O₃≤15.0, 1.20≤MgO≤1.90, 3.50≤CaO≤5.00, 0≤ZnO≤3.50, 0.10≤Li₂O≤0.50, and 0.10≤Na₂O≤0.30, the glass composition having a permittivity of less than 5.0 at a frequency of 1 MHz.

In still another example, the glass composition can be a glass composition consisting essentially of, in wt %, 50.0≤SiO₂≤53.0, 26.0≤B₂O₃≤29.0, 14.0≤Al₂O₃≤15.0, 1.40≤MgO≤1.90, 4.50≤CaO≤5.00, 0.10≤Li₂O≤0.30, and 0.10≤Na₂O≤0.30, the glass composition having a ratio CaO/(MgO+CaO+ZnO) of 0.7 to 0.8, the glass composition having a permittivity of less than 5.0 at a frequency of 1 MHz.

In still another example, the glass composition can be a glass composition consisting essentially of, in wt %, 50.0≤SiO₂≤52.0, 27.0≤B₂O₃≤29.0, 14.0≤Al₂O₃≤15.0, 1.40≤MgO≤1.60, 4.60≤CaO≤5.00, 0.10≤Li₂O≤0.30, and 0.10≤Na₂O≤0.30, the glass composition having a ratio CaO/(MgO+CaO+ZnO) of 0.70 to 0.80, the glass composition having a permittivity of less than 5.0 at a frequency of 1 MHz.

The glass composition of the present invention can be a composition substantially free of F₂. In the glass composition of Patent Literature 2 (JP 2010-508226 A), F₂ is added in an amount of substantially up to 2%, and this addition of F₂ is intended to improve the meltability of the glass composition, lower the viscosity at melting, and reduce the amounts of bubbles and scum formed during melting. The glass composition of the present invention can, owing to the above-described balance among the contents of the various components, be a low-permittivity glass composition that is substantially free of F₂ but with which the occurrence of devitrification and the inclusion of bubbles in glass fibers to be formed or in a shaped glass material to be formed can be reduced even when the glass fibers have a small fiber diameter or the shaped glass material has a small thickness.

The glass composition of the present invention can be a composition substantially free of SrO and/or BaO. The glass composition of Patent Literature 3 (JP 2009-286686 A) contains SrO and BaO which are intended to lower the viscosity of the glass composition at melting. The glass composition of the present invention can, owing to the above-described balance among the contents of the various components, be a low-permittivity glass composition that is substantially free of SrO and/or BaO but with which the occurrence of devitrification and the inclusion of bubbles in glass fibers to be formed or in a shaped glass material to be formed can be reduced even when the glass fibers have a small fiber diameter or the shaped glass material has a small thickness.

It is considered that the purpose of the addition of F₂ or the addition of SrO and BaO in a conventional glass composition as mentioned above is to improve the meltability and defoaming performance of the glass composition and at the same time avoid as much as possible the incorporation of alkali metal oxides, MgO, and CaO which act to significantly increase the permittivity of the glass composition. However, F₂, SrO, and BaO are known as harmful substances, and it is desirable to avoid as much as possible the incorporation of these substances in glass compositions. Also in this respect, the glass composition of the present invention which can be substantially free of F₂, SrO, and BaO is advantageous. For example, when a glass composition contains harmful substances such as F₂, recycling or disposal of glass fibers formed from the composition requires grate care to prevent the harmful substances from leaking into the surrounding environment. Additionally, in production of the glass fibers, the use of an expensive collection system is needed to prevent discharge of the harmful substances to the environment.

The term “substantially free” as used herein means that the content of a substance is less than 0.1%. This term is intended to mean that impurities such as those derived from the glass raw materials, the apparatus for producing the glass composition, and the apparatus for shaping the glass composition may be contained.

The permittivity of the glass composition of the present invention is less than 5.0 at a frequency of 1 MHz. The permittivity of the glass composition of the present invention can be 4.9 or less or even 4.8 or less at a frequency of 1 MHz, depending on the components and their proportions in the glass composition.

The glass composition of the present invention can be a glass composition that does not devitrify even when placed, for example, at least one temperature selected from 1150° C., 1200° C., and 1250° C. for 2 hours. The glass composition of the present invention can be a glass composition that does not devitrify even when placed at any of the temperatures of 1150° C., 1200° C., and 1250° C. for 2 hours. In these cases, in particular in the latter case, the occurrence of devitrification during the fiber forming process of the glass composition, in particular during forming of glass fibers having a small fiber diameter, can be reduced. Likewise, the occurrence of devitrification during forming of the glass composition into a thin shaped glass material such as glass flakes having a small thickness can be reduced. The temperatures of 1150° C., 1200° C., and 1250° C. correspond to temperatures considered to be employed in forming of glass fibers having a small fiber diameter or, specifically, glass temperatures at which a fiber forming process is carried out in a melt-forming apparatus. Likewise, the temperatures of 1150° C., 1200° C., and 1250° C. correspond to temperatures considered to be employed in formation of a thin shaped glass material such as glass flakes having a small thickness or, specifically, glass temperatures at which a shaping process is carried out in a melt-shaping apparatus.

The applications of the glass composition of the present invention are not limited. The glass composition is used, for example, for glass fibers or shaped glass materials. Examples of the shaped glass materials include glass flakes. That is, the glass composition of the present invention can be a glass composition for glass fibers, a glass composition for shaped glass materials, or a glass composition for glass flakes.

The glass composition of the present invention is a glass composition with which the occurrence of devitrification and the inclusion of bubbles in glass fibers to be formed can be reduced even when the glass fibers have a small fiber diameter. The term “glass fibers having a small fiber diameter” refers, for example, to glass fibers having an average fiber diameter of 3 to 6 μm. That is, the glass composition of the present invention can be a glass composition for small-diameter glass fibers or, more specifically, can be a glass composition for glass fibers having an average fiber diameter of 3 to 6 μm. Additionally, as previously described, the effect of the present invention is more significant when glass fibers produced from the glass composition of the present invention are used in printed boards. In view of this fact, the glass composition of the present invention can be a glass composition for glass fibers for use in printed boards (printed wiring boards and printed circuit boards).

Likewise, the glass composition of the present invention can be a glass composition with which the occurrence of devitrification and the inclusion of bubbles in a shaped glass material to be formed such as glass flakes can be reduced even when the shaped glass material has a small thickness. The term “having a small thickness” means that the thickness is, for example, 0.1 to 2.0 μm. Additionally, as previously described, the effect of the present invention is more significant when a shaped glass material produced from the glass composition of the present invention (a shaped glass material composed of the glass composition of the present invention) is used in printed boards. In view of this fact, the glass composition of the present invention can be a glass composition for a shaped glass material for use in printed boards.

In view of the usability in printed boards, the glass composition of the present invention can be a glass composition for printed boards.

[Glass Fibers]

Glass fibers of the present invention are composed of the glass composition of the present invention. The details of the structure of the glass fibers are not particularly limited. As long as the glass fibers are composed of the glass composition of the present invention, the glass fibers can have the same structure as conventional glass fibers. As described above, the glass composition of the present invention is a low-permittivity glass composition with which the occurrence of devitrification and the inclusion of bubbles in glass fibers to be formed can be reduced even when the glass fibers have a small fiber diameter. Thus, the glass fibers of the present invention can be glass fibers having a small fiber diameter. That is, low-permittivity glass fibers having a small fiber diameter are an embodiment of the glass fibers of the present invention.

The glass fibers of the present invention can be small-diameter glass fibers having an average fiber diameter of, for example, 3 to 6 μm. Depending on the components and their proportions in the glass composition, the glass fibers can be small-diameter glass fibers having an average diameter of 3 to 4.6 μm or even 3 to 4.3 μm.

The glass fibers of the present invention can be glass fibers in which the number of bubbles per cm³ is 200 cm⁻³ or less. Depending on the components and their proportions in the glass composition, the glass fibers can be glass fibers in which the number of bubbles per cm³ is 170 cm⁻³ or less, 150 cm⁻³ or less, or even 130 cm⁻³ or less. The average fiber diameter of such glass fibers is, for example, 3 to 6 μm and can, depending on the components and their proportions in the glass composition, be 3 to 4.6 μm or even 3 to 4.3 μm.

The glass fibers of the present invention can be glass fibers having a permittivity of less than 5.0 at a frequency of 1 MHz. Depending on the components and their proportions in the glass composition, the glass fibers can be glass fibers having a permittivity of 4.9 or less or even 4.8 or less at a frequency of 1 MHz.

Additionally, since the glass composition of the present invention is a composition with which the occurrence of devitrification and the inclusion of bubbles in glass fibers to be formed can be reduced even when the glass fibers have a small fiber diameter, the glass fibers of the present invention can be continuous glass fibers (filament fibers) and, more specifically, can be continuous glass fibers having a small fiber diameter and low permittivity as described above.

Patent Literature 1 (JP 62(1987)-226839 A) merely discloses forming of glass fibers having a relatively large fiber diameter which is 8 to 13 μm. Patent Literature 1 gives no consideration or discussion as to production of glass fibers having a small fiber diameter (for example, glass fibers having an average fiber diameter of 3 to 6 μm). When the glass composition specifically disclosed in Patent Literature 1 is used to produce glass fibers having a small fiber diameter, fiber breakage during fiber forming and strength decrease are likely to occur due to formation of fine crystals (devitrification).

The applications of the glass fibers of the present invention are not limited. The glass fibers are used, for example, in printed boards. In the case of use in printed boards, the feature of being glass fibers having a low permittivity and a small fiber diameter is more advantageous than in other cases.

The glass fibers of the present invention can be formed into a glass yarn. This glass yarn includes the glass fibers, typically the continuous glass fibers, of the present invention. This glass yarn can include glass fibers other than the glass fibers of the present invention. However, to effectively take advantage of the above-described features of the glass fibers of the present invention, the glass yarn preferably consists of the glass fibers of the present invention.

The structure of the glass yarn is not limited as long as the glass yarn includes the glass fibers of the present invention. In an example, the glass yarn is a glass yarn in which the number of the continuous glass fibers (the number of filament fibers) is 30 to 200. Like the applications of the glass fibers, the applications of the glass yarn are not particularly limited either. The glass yarn is used, for example, in printed boards. In the case of use in printed boards, the glass yarn can be a glass yarn in which the number of filament fibers is, for example, 30 to 100, 30 to 70, or 30 to 60. In these cases, for example, a thin glass cloth can be more easily and reliably produced, and more reliable adaptation to thickness reduction of printed boards can be achieved.

In another example, the glass yarn is a glass yarn having a count of 1 to 6 tex and can be a glass yarn having a count of 1 to 3 tex. In these cases, for example, a thin glass cloth can be more easily and reliably produced, and more reliable adaptation to thickness reduction of printed boards can be achieved.

In still another example, the glass yarn is a glass yarn having a strength of 0.4 N/tex or more and can be a glass yarn having a strength of 0.6 N/tex or more or even 0.7 N/tex or more. This strength corresponds to the strength of the glass fibers.

The glass yarn can be a glass yarn having two or more of the features illustrated above in any combination.

The method for producing the glass fibers of the present invention is not limited to a particular method, and the glass fibers can be produced by a known method using the glass composition of the present invention. For example, when glass fibers having an average fiber diameter of about 3 to 6 μm is produced, the following exemplary method can be employed: the glass composition of the present invention is placed in a glass melting furnace and melted into molten glass, and then the molten glass is formed into fibers by drawing it through a large number of nozzles provided at the bottom of a bushing of a drawing furnace. In this manner, glass fibers composed of the glass composition of the present invention can be produced. The glass fibers can be continuous glass fibers (filament fibers). The melting temperature in the melting furnace is, for example, 1300 to 1650° C., preferably 1400 to 1650° C., and more preferably 1500 to 1650° C. In these cases, even when the glass fibers to be formed have a small fiber diameter, the occurrence of devitrification and the inclusion of bubbles in the glass fibers can be further reduced and, in addition, excessive increase in forming tension can be prevented, so that the properties (such as strength) and quality of the resulting glass fibers are more reliably ensured.

The following presents considerations by the present inventors, which explain the basis for the above-described additional effects achieved by using the glass composition of the present invention and melting the composition at the above preferred melting temperature when glass fibers having a small fiber diameter are to be formed. A first possible approach to produce glass fibers having a small fiber diameter is to increase the drawing rate (forming rate) of molten glass from a drawing furnace, and a second possible approach is to decrease the temperature of nozzles. However, the first approach may fail to allow sufficient glass melting time for facilitating defoaming of molten glass in the drawing furnace. When sufficient time is not allowed for melting, fiber breakage occurs during fiber forming due to the inclusion of bubbles or, even if glass fibers are obtained, the fibers have a decreased strength. Additionally, the increase in drawing rate entails an increase in the tension (forming tension) acting on fibers during fiber forming, and this increased tension may also lead to fiber breakage during fiber forming, decrease in strength of the resulting glass fibers, and quality degradation of the fibers. The quality degradation of the glass fibers due to excessive increase in forming tension is caused, for example, for the following reason. For winding of formed glass fibers, a winding rotary device called “collet” is generally used. Specifically, the collet is provided with a plurality of fingers arranged on the outer periphery of a main body of the collet, and the fingers move outwardly in the radial direction of the collet during rotation of the collet and sink into the main body of the collet when the collet is at rest. Excessive increase in forming tension causes the wound glass fibers to have kinks due to recesses between the fingers, and these kinks degrade the quality of the glass fibers. This quality degradation leads to, for example, poor appearance and/or fiber-opening failure of a glass cloth produced using the glass fibers.

The second approach requires decreasing the melting temperature in the melting furnace. The decrease in melting temperature makes the melting temperature closer to the devitrification temperature of the glass composition, and increases the viscosity of the molten glass, which may preclude maintenance of sufficient defoaming performance. Additionally, the forming tension also increases. This may result in fiber breakage during fiber forming, decrease in strength of the resulting glass fibers, and quality degradation of the fibers.

For example, in Patent Literature 1, glass raw materials are melted at a temperature of 1300 to 1350° C., and then the molten glass is formed into glass fibers having a relatively large fiber diameter which is 8 to 13 μm. According to the present invention, using the glass composition of the present invention and melting the composition at the above preferred melting temperature provide the following effects: the above-described effect attributed to the glass composition of the present invention is obtained; sufficient time can be allowed for glass melting to facilitate defoaming of molten glass in a drawing furnace, in addition to which the viscosity of the molten glass can be lowered to ensure sufficient defoaming performance; and excessive increase in forming tension can be prevented even when the drawing rate is increased. Therefore, even when the glass fibers to be formed have a small fiber diameter, the occurrence of devitrification and the inclusion of bubbles in the glass fibers can be further reduced and, in addition, excessive increase in forming tension can be prevented, so that the properties (such as strength) and quality of the resulting glass fibers are more reliably ensured. The quality improvement of the glass fibers leads to, for example, good appearance and/or high degree of fiber opening of a glass cloth produced using the glass fibers.

From these aspects, the present specification discloses a method for producing glass fibers, the method including: melting the glass composition of the present invention (or glass raw materials which are formed into the glass composition of the present invention as a result of melting) at a melting temperature of 1400° C. or higher, preferably 1400 to 1650° C., more preferably 1500 to 1650° C. to form molten glass; and forming the formed molten glass into glass fibers. With this method, glass fibers having a small fiber diameter can be formed and, more specifically, glass fibers having an average fiber diameter of, for example, 3 to 6 μm, or 3 to 4.6 μm, or even 3 to 4.3 μm, can be formed. The glass fibers can be low-permittivity glass fibers having a permittivity of less than 5.0, or 4.9 or less, or even 4.8 or less at a frequency of 1 MHz. The glass fibers can be continuous fibers.

A glass strand can be formed by applying a sizing agent to the surface of formed glass fibers and bundling a plurality of such glass fibers (for example, 10 to 120 glass fibers) together. This glass strand includes the glass fibers of the present invention. Glass yarns can be obtained by winding the thus formed glass strands around a tube (for example, a paper tube) on a collet rotating at a high speed to form a cake, then unwinding the strands from the outer layer of the cake, twisting the strands under air drying, winding the strands around a bobbin or other means, and further twisting the strands.

[Glass Cloth]

A glass cloth of the present invention is composed of glass fibers of the present invention. The details of the structure of the glass cloth are not particularly limited. As long as the glass cloth includes the glass fibers of the present invention, the glass cloth can have the same structure as conventional glass cloths. For example, the weave of the glass cloth is not particularly limited and can be plain weave, satin weave, twill weave, mat weave, rib weave, or the like. Among these exemplary weaves, plain weave is preferred. The glass cloth of the present invention may include glass fibers other than the glass fibers of the present invention. However, to reliably obtain the various effects described above, the glass fibers included in the glass cloth preferably consist of the glass fibers of the present invention. The glass cloth of the present invention can be a glass cloth composed of low-permittivity glass fibers having a small fiber diameter.

The thickness of the glass cloth of the present invention, as expressed by a thickness measured according to 7.10.1 of JIS R 3420: 2013, is, for example, 20 μm or less. Depending on the structures of the glass fibers and the glass cloth, the thickness can be 10 to 20 μm or even 10 to 15 μm. The ability to obtain a glass cloth having such a thickness allows more reliable adaptation to thickness reduction of printed boards.

The mass of the glass cloth of the present invention, as expressed by a cloth mass measured according to 7.2 of JIS R 3420: 2013, is, for example, 20 g/m² or less. Depending on the structures of the glass fibers and the glass cloth, the cloth mass can be 8 to 20 g/m² or even 8 to 13 g/m². The ability to obtain a glass cloth having such a cloth mass allows more reliable adaptation to thickness reduction of printed boards.

The number of glass fibers per unit length (25 mm) in the glass cloth of the present invention (the weave density of the glass cloth of the present invention) is, for example, 80 to 130 per 25 mm for both warp and weft. Depending on the structures of the glass fibers and the glass cloth, the weave density can be 80 to 110 or even 90 to 110. With the glass cloth having such a weave density, it is possible to more reliably ensure both that the thickness of the glass cloth is reduced and that the number of interlacing points between warp and weft is increased to reduce the likelihood of bias or bowed filling of the glass cloth so as to prevent formation of pinholes when the cloth is impregnated with a resin.

The air permeability of the glass cloth of the present invention is, for example, 200 cm³/(cm²·sec) or less. Depending on the structures of the glass fibers and the glass cloth, the air permeability can be 100 to 200 cm³/(cm²·sec) or even 100 to 150 cm³/(cm²·sec). With the glass cloth having such an air permeability, it is possible to more reliably ensure both the thickness reduction of the glass cloth and the prevention of the formation of pinholes. In order to achieve fiber opening that allows the glass cloth to have such an air permeability, it is preferable, in forming of the glass fibers, to melt the glass composition of the present invention or glass raw materials, which are formed into the glass composition of the present invention as a result of melting, at the melting temperature described above which is 1400° C. or higher and preferably 1400 to 1650° C.

The method for producing the glass cloth of the present invention is not limited, and the glass cloth can be produced by a known method using the glass fibers of the present invention. In an exemplary method, glass yarns including the glass fibers of the present invention are subjected to warping and sizing, and the resulting glass yarns are used as warp yarns, between which other glass yarns including the glass fibers of the present invention are inserted as weft yarns. For the weft insertion, various weaving machines can be used, such as a jet loom (specific examples include an air-jet loom and a water-jet loom), a Sulzer loom, and a rapier loom.

The glass cloth may be subjected to fiber opening. In this case, for example, the thickness of the glass cloth can be further reduced. The details of the method for fiber opening are not limited, and examples of the method include: fiber opening by pressure of water stream; fiber opening by high-frequency vibration using water as a medium (specific examples of the water as the medium include degassed water, ion-exchanged water, deionized water, electrolyzed cation water, and electrolyzed anion water); and fiber opening by compression using rolls or other means. The fiber opening may be carried out concurrently with weaving of the glass cloth or may be carried out after weaving of the glass cloth. The fiber opening may be carried out simultaneously with other various processes such as heat cleaning and surface treatment or may be carried out after such processes.

When a substance such as a sizing agent remains attached to the woven glass cloth, a process for removing the substance, such as heat cleaning, can be additionally carried out. The glass cloth subjected to such a process exhibits high impregnability with a matrix resin and high adhesion to the resin when used, for example, in printed boards. After or without this process, the woven glass cloth may be surface-treated with a silane coupling agent or other agent. The surface treatment can be accomplished by a known method such as a method in which a silane coupling agent is impregnated into, spread over, or sprayed onto the glass cloth.

The applications of the glass cloth of the present invention are not limited. The glass cloth is used, for example, in printed boards. In the case of use in printed boards, the feature of being composed of glass fibers having a low permittivity and a small fiber diameter is more advantageous than in other cases.

### EXAMPLES

Hereinafter, the present invention will be described in more detail by examples. The present invention is not limited to the examples presented below.

### Examples 1 to 11 and Comparative Examples 1 to 6

First, glass raw materials were weighed to give compositions shown in Tables 1 and 2 below (the contents of the components are expressed in wt %, except that, for Comparative Example 6, the contents are expressed in parts by weight), and the glass raw materials were mixed to homogeneity to prepare a glass raw material mixture batch. Next, the mixture batch thus prepared was introduced into a crucible made of platinum-rhodium alloy and heated in an indirect-heating electric furnace set at 1600° C. under air for 3 hours or more. Thus, molten glass was obtained. Next, the obtained molten glass was poured into a fire resistant mold and cast-molded. The resulting molded body was then cooled slowly to room temperature by an annealing furnace. In this manner, glass composition samples to be used for evaluation were prepared.

The glass compositions prepared in Examples 1 to 8 had the following composition on an oxide basis: SiO₂, 50.4 wt % or more and 53.6 wt % or less; B₂O₃, 25.5 wt % or more and 27.5 wt % or less; Al₂O₃, 12.1 wt % or more and 15.0 wt % or less; Li₂O, 0.18 wt % or more and 0.45 wt % or less; Na₂O, 0.12 wt % or more and 0.30 wt % or less; MgO, 0.91 wt % or more and 1.36 wt % or less; CaO, 3.31 wt % or more and 5.21 wt % or less; and ZnO, 1.83 wt % or more and 2.73 wt % or less (see Table 1).

The glass compositions prepared in Examples 1 to 9 had the following composition on an oxide basis: SiO₂, 50.4 wt % or more and 53.6 wt % or less; B₂O₃, 25.5 wt % or more and 28.0 wt % or less; Al₂O₃, 12.1 wt % or more and 15.0 wt % or less; Li₂O, 0.17 wt % or more and 0.45 wt % or less; Na₂O, 0.12 wt % or more and 0.30 wt % or less; MgO, 0.91 wt % or more and 1.50 wt % or less; CaO, 3.31 wt % or more and 5.21 wt % or less; and ZnO, 0 wt % or more and 2.73 wt % or less (see Table 1).

The glass compositions prepared in Examples 1 to 8 and Example 11 had the following composition on an oxide basis: SiO₂, 50.4 wt % or more and 53.6 wt % or less; B₂O₃, 25.5 wt % or more and 27.5 wt % or less; Al₂O₃, 12.1 wt % or more and 15.0 wt % or less; Li₂O, 0.18 wt % or more and 0.45 wt % or less; Na₂O, 0.12 wt % or more and 0.30 wt % or less; MgO, 0.91 wt % or more and 1.82 wt % or less; CaO, 3.31 wt % or more and 5.21 wt % or less; and ZnO, 0 wt % or more and 2.73 wt % or less (see Table 1).

The glass compositions prepared in Examples 1 to 11 had the following composition on an oxide basis: SiO₂, 50.4 wt % or more and 53.6 wt % or less; B₂O₃, 25.5 wt % or more and 28.8 wt % or less; Al₂O₃, 12.1 wt % or more and 15.0 wt % or less; Li₂O, 0.17 wt % or more and 0.45 wt % or less; Na₂O, 0.12 wt % or more and 0.30 wt % or less; MgO, 0.91 wt % or more and 1.82 wt % or less; CaO, 3.31 wt % or more and 5.21 wt % or less; and ZnO, 0 wt % or more and 2.73 wt % or less (see Table 1).

The glass samples prepared as above were evaluated for the number of bubbles, the devitrification resistance, and the permittivity at a frequency of 1 MHz by the following procedures.

[Number of Bubbles]

A 5-mm-square frame was set approximately at the center of the prepared glass sample, the area defined by the frame in the glass sample was observed with a stereomicroscope at a several-fold magnification, and the number of bubbles seen within the frame was determined. Apart from this procedure, the thickness of the glass sample was measured at the observed area, and the number of bubbles per cm³ was calculated from the measured thickness and the determined number of bubbles. The calculated number of bubbles was defined as the number of bubbles formed in the glass sample (unit: cm⁻³).

[Devitrification Resistance]

1 to 2 g of the prepared glass sample was placed on a plate made of platinum-rhodium alloy, and this plate with the glass sample was placed in an electric furnace set at 1150° C., 1200° C., or 1250° C. for 2 hours, after which the glass sample was taken out of the furnace and left to cool. After the cooling, the transparency of the glass sample was examined by naked eye. When the glass sample showed some cloudiness, it was determined that devitrification occurred, while when the glass sample showed no cloudiness and maintained transparency, it was determined that devitrification did not occur. Additionally, glass fibers having an average fiber diameter of 3 μm were formed and examined. The result was that glass compositions from which such glass fibers having a small fiber diameter were successfully formed without fiber breakage caused by devitrification were glass compositions that did not devitrify when placed in the above electric furnace at at least one heating temperature selected from 1150° C., 1200° C., and 1250° C. for 2 hours, in particular glass compositions that did not devitrify at any of the heating temperatures. Thus, glass compositions that did not devitrify at any of the temperatures of 1150° C., 1200° C., and 1250° C. were determined to be glass compositions with which the occurrence of devitrification during forming of glass fibers having a small fiber diameter is particularly reduced. Such glass compositions were rated “Good”. Glass compositions that devitrified at one or two of the heating temperatures were rated “Acceptable”. Glass compositions that devitrified at all of the three heating temperatures were determined to be glass compositions with which the occurrence of devitrification is not reduced, and such glass compositions were rated “Unacceptable”. The temperatures of 1150° C., 1200° C., and 1250° C. correspond to temperatures employed in the process of forming glass fibers having a small fiber diameter, in particular to a temperature during heating at the start-up of the bushing and a temperature during formation of glass into fibers.

[Permittivity]

The permittivity at a frequency of 1 MHz was measured according to ASTM D150-87. The measurement temperature was 25° C. The lower the permittivity of a glass composition is, the smaller the dielectric loss of a printed board including glass fibers formed from the glass composition is.

TABLE 1

| | | | | | | | | | | | Example |
|---|---|---|---|---|---|---|---|---|---|---|---|
| | Example 1 | Example 2 | Example 3 | Example 4 | Example 5 | Example 6 | Example 7 | Example 8 | Example 9 | Example 10 | 11 |
| SiO₂ | 52.2 | 51.4 | 50.4 | 51.7 | 51.6 | 53.6 | 51.0 | 52.2 | 50.9 | 51.0 | 52.7 |
| B₂O₃ | 25.8 | 25.5 | 27.5 | 25.6 | 26.6 | 26.1 | 27.0 | 25.8 | 28.0 | 28.8 | 26.1 |
| Al₂O₃ | 14.3 | 15.0 | 14.4 | 14.1 | 14.1 | 12.1 | 14.3 | 14.3 | 14.5 | 12.4 | 14.4 |
| Li₂O | 0.18 | 0.42 | 0.18 | 0.20 | 0.18 | 0.45 | 0.18 | 0.18 | 0.17 | 0.18 | 0.18 |
| Na₂O | 0.12 | 0.28 | 0.12 | 0.13 | 0.12 | 0.30 | 0.12 | 0.12 | 0.13 | 0.12 | 0.12 |
| MgO | 0.91 | 1.27 | 0.92 | 1.02 | 0.91 | 1.29 | 0.91 | 1.36 | 1.50 | 1.30 | 1.82 |
| CaO | 4.66 | 3.55 | 4.64 | 5.21 | 4.66 | 3.57 | 4.66 | 3.31 | 4.80 | 3.59 | 4.68 |
| ZnO | 1.83 | 2.58 | 1.84 | 2.04 | 1.83 | 2.59 | 1.83 | 2.73 | — | 2.61 | — |
| F₂ | — | — | — | — | — | — | — | — | — | — | — |
| Number of | 122 | 123 | 184 | 143 | 130 | 198 | 166 | 167 | 163 | 70 | 109 |
| bubbles | | | | | | | | | | | |
| [cm⁻³] | | | | | | | | | | | |
| Devitrification | Good | Good | Good | Good | Good | Good | Good | Good | Good | Acceptable | Good |
| resistance | | | | | | | | | | | |
| Permittivity | 4.79 | 4.90 | 4.80 | 4.90 | 4.79 | 4.77 | 4.80 | 4.73 | 4.77 | 4.65 | 4.78 |

TABLE 2

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| SiO₂ | 50.3 | 55.8 | 50.4 | 54.5 | 48.9 | 53.4 |
| B₂O₃ | 24.9 | 29.9 | 26.2 | 26.8 | 24.0 | 26.8 |
| Al₂O₃ | 17.0 | 9.9 | 15.7 | 11.1 | 19.4 | 12.9 |
| Li₂O | 0.18 | 0.18 | 0.18 | 0.18 | 0.18 | — |
| Na₂O | 0.12 | 0.12 | 0.12 | 0.12 | 0.12 | — |
| MgO | 1.30 | — | 1.10 | 0.89 | 0.91 | — |
| CaO | 3.59 | 4.10 | 4.08 | 4.60 | 4.66 | 5.91 |
| ZnO | 2.61 | — | 2.22 | 1.81 | 1.83 | — |
| F₂ | — | — | — | — | — | — |
| Number of | 183 | 345 | 125 | 270 | 176 | 271 |
| bubbles | | | | | | |
| [cm⁻³] | | | | | | |
| Devitrification | Unacceptable | Good | Unacceptable | Good | Unacceptable | Good |
| resistance | | | | | | |
| Permittivity | 4.89 | 4.31 | 4.85 | 4.64 | 5.07 | 4.61 |

Tables 1 and 2 reveal the following facts.

For the glass compositions of Examples 1 to 9 and Example 11, the number of bubbles observed was in the range of 109 cm⁻³ to 198 cm⁻³. All of these glass compositions showed no formation of white crystals and remained in the form of transparent glass after being placed for 2 hours at any of the temperatures of 1150° C., 1200° C., and 1250° C. which are temperatures considered to be employed in forming of glass fibers having a small fiber diameter. For the glass compositions of Examples 1 to 9 and Example 11, the permittivity at a frequency of 1 MHz was in the range of 4.7 to 4.9. By contrast, for the glass compositions of Comparative Examples 1 to 6, the number of bubbles observed was 270 cm⁻³ or more, or white crystals were formed (devitrification occurred) as a result of 2-hour placement at all of the temperatures of 1150° C., 1200° C., and 1250° C. which are temperatures considered to be employed in forming of glass fibers having a small fiber diameter. The permittivity of the glass composition of Comparative Example 5 at a frequency of 1 MHz was 5.0 or more.

Among the glass compositions of Examples 1 to 9 and Example 11 in which the inclusion of bubbles was reduced and in which the occurrence of devitrification was significantly reduced, particularly distinctive glass compositions will be described in more detail.

In the glass composition of Example 1, the content of B₂O₃ was significantly low, specifically 25.8 wt %. However, the content of Al₂O₃ was 14.3 wt %, the content of SiO₂ was 52.2 wt %, the content of MgO was 0.91 wt %, the content of Li₂O was 0.18 wt %, the content of Na₂O was 0.12 wt %, the content of CaO was 4.66 wt %, and the content of ZnO was 1.83 wt %. Owing to this, the glass composition attained good properties; namely, a sufficiently low permittivity of 4.79 was achieved, the number of bubbles was 122 cm⁻³, and devitrification did not occur at any of the temperatures considered to be employed in forming of glass fibers having a small fiber diameter.

For the glass composition of Example 2, both the content of SiO₂ and the content of B₂O₃ were relatively low; specifically, the content of SiO₂ was 51.4 wt %, and the content of B₂O₃ was 25.5 wt %. Due to this, the permittivity at a frequency of 1 MHz was somewhat high, specifically 4.90. However, the content of Al₂O₃ was 15.0 wt % and the content of MgO was 1.27 wt %, besides which Li₂O was added up to 0.42 wt %, and Na₂O was added up to 0.28 wt %. Further, the content of CaO was 3.55 wt %, and the content of ZnO was 2.58 wt %. Owing to this, the glass composition of Example 2 attained good properties; namely, the number of bubbles was 123 cm⁻³, and devitrification did not occur at any of the temperatures considered to be employed in forming of glass fibers having a small fiber diameter.

Next, among the glass compositions of Comparative Examples 1 to 6, particularly distinctive glass compositions will be described in more detail.

The glass composition of Comparative Example 1 is a glass composition corresponding to Example 9 of Patent Literature 1 (JP 62(1987)-226839 A). This composition is characterized by having a high Al₂O₃ content and devitrified at all of the temperatures considered to be employed in forming of glass fibers having a small fiber diameter. Using the glass composition of Comparative Example 1, forming of glass fibers having an average fiber diameter of 3 μm was attempted. However, devitrification occurred, and the devitrification caused a high incidence of fiber breakage, in consequence of which fibers were not formed almost at all.

The glass composition of Comparative Example 2 is a glass composition corresponding to Example 5 of Patent Literature 1. This composition is characterized by having an Al₂O₃ content as low as 9.9 wt %, a B₂O₃ content as high as 29.9 wt %, and a SiO₂ content as high as 55.8 wt % and did not devitrify at any of the temperatures considered to be employed in forming of glass fibers having a small fiber diameter. However, presumably due to an increase in viscosity at melting, the homogeneity of the glass composition at melting was reduced, and the number of bubbles observed was very large, specifically 345 cm⁻³. Using the glass composition of Comparative Example 2, forming of glass fibers having an average fiber diameter of 3 μm was attempted. However, compositional unevenness occurred and caused a high incidence of fiber breakage, in consequence of which fibers were not formed almost at all. In a slight amount of glass fibers barely obtained, a large number of bubbles were observed.

The glass composition of Comparative Example 4 is characterized by having an Al₂O₃ content as low as 11.1 wt % and did not devitrify at any of the temperatures considered to be employed in forming of glass fibers having a small fiber diameter. However, the number of bubbles observed was very large, specifically 270 cm⁻³, presumably because of an increase in viscosity at melting which was caused by the fact that the content of SiO₂ was as high as 54.5 wt %. Using the glass composition of Comparative Example 4, forming of glass fibers having an average fiber diameter of 3 μm was attempted. Glass fibers were able to be formed indeed; however, many hollow fibers were found among the glass fibers obtained.

The glass composition of Comparative Example 5 had an Al₂O₃ content as high as 19.4 wt % and devitrified at all of the temperatures considered to be employed in forming of glass fibers having a small fiber diameter. Additionally, the permittivity at a frequency of 1 MHz was more than 5.0, specifically 5.07, because the content of SiO₂ was as low as 48.9 wt % and the content of B₂O₃ was as low as 24.0 wt %. It is expected that glass fibers and a glass cloth formed from the glass composition of Comparative Example 5 will have a large dielectric loss and that when, for example, such fibers and cloth are used in a printed board, the board will suffer a decrease in transmission rate.

The glass composition of Comparative Example 6 corresponds to a composition as obtained by removing the component F₂ from the composition of Example E5 of Patent Literature 2 (JP 2010-508226 A). This composition has a relatively high SiO₂ content of 53.4 parts by weight and is free of MgO, Li₂O, Na₂O, K₂O, and TiO₂. For the composition of Comparative Example 6, presumably due to an increase in viscosity at melting, the homogeneity of the glass composition at melting was reduced, and the number of bubbles observed was very large, specifically 271 cm⁻³.

Examples and Comparative Examples described above demonstrated that: the glass composition of the present invention can be used for glass fibers, in particular glass fibers having a small fiber diameter and intended for use in a printed board on which high density integration is to be accomplished; and the glass composition of the present invention, when used in production of glass fibers, in particular production of glass fibers having a small fiber diameter, exhibits good forming properties and makes it possible to provide glass fibers of stable quality with high production efficiency.

### Example 12

In Example 12, glass fibers were produced from pellets of the glass composition prepared in Example 1. Specifically, the pellets were placed in a glass melting furnace and melted at a melting temperature of 1550° C., and then the molten glass was drawn through a large number of nozzles provided at the bottom of a bushing in a drawing furnace. While a sizing agent was applied to the resulting glass strands (average fiber diameter: 4.1 μm, number of filament fibers: 50), the glass strands were wound around a tube on a collet rotating at a high speed to form a cake. Next, the strands were continuously unwound from the outer layer of the formed cake, twisted under air drying, wound around a bobbin, and further twisted. In this manner, glass yarns (count: 1.7 tex) were obtained. The composition of the obtained glass yarns was identical to that of the glass composition of Example 1.

Next, the glass yarns obtained were used as warp yarns and weft yarns for weaving by means of an air-jet loom. As a result, a plain-weave glass cloth was formed in which the number of warp yarns per unit length (hereinafter referred to as “warp density”; unit length=25 mm) was 95 and the number of weft yarns per unit length (hereinafter referred to as “weft density”; unit length=25 mm) was 95.

Next, the forming sizing agent and the weaving sizing agent remaining attached to the formed glass cloth were removed by heating at 400° C. for 30 hours. A silane coupling agent as a surface treatment agent was then applied to the glass cloth from which the sizing agents were removed. Next, fiber opening was carried out by water stream process to obtain a glass cloth of Example 12. The glass cloth obtained had a warp density of 95, a weft density of 95, a thickness of 15 μm, and a mass of 12.7 g/m². The results of evaluation of the glass fibers, glass yarns, and glass cloth which were produced in Example 12 are collectively shown in Table 3 below. The methods used to evaluate the various items will be described later.

### Example 13

Glass yarns and a glass cloth were obtained in the same manner as in Example 12, except that pellets of the glass composition prepared in Example 4 were used instead of the pellets of the glass composition prepared in Example 1 and that the melting temperature was 1600° C. The obtained glass yarns had a count of 1.7 tex and had a composition identical to that of the glass composition of Example 4. The obtained glass cloth had a warp density of 95, a weft density of 95, a thickness of 15 μm, and a mass of 12.7 g/m². The results of evaluation of the glass fibers, glass yarns, and glass cloth which were produced in Example 13 are collectively shown in Table 3 below.

### Comparative Example 7

Glass yarns and a glass cloth were obtained in the same manner as in Example 12, except that pellets of the glass composition prepared in Comparative Example 1 were used instead of the pellets of the glass composition prepared in Example 1 and that the melting temperature was 1600° C. The obtained glass yarns had a count of 1.7 tex and had a composition identical to that of the glass composition of Comparative Example 1. The obtained glass cloth had a warp density of 95, a weft density of 95, a thickness of 15 μm, and a mass of 12.7 g/m². The results of evaluation of the glass fibers, glass yarns, and glass cloth which were produced in Comparative Example 7 are collectively shown in Table 3 below.

The following describes the methods used to evaluate the various items for the glass fibers, glass yarns, and glass cloth which were produced in Examples 12 and 13 and Comparative Example 7.

[Forming Workability of Glass Fibers]

The forming workability of the glass fibers was evaluated by the ratio of an actual number of cakes to an ideal number of cakes. The actual number of cakes refers to the number of actual cakes formed of wound glass fibers having a predetermined length which were actually obtained by fiber forming operation at a constant drawing rate and constant winding time in an operation period of time (12 hours or more) without fiber breakage. The ideal number of cakes refers to the number of ideal cakes which are to be obtained by fiber forming operation at the same constant drawing rate and constant winding time in the same operation period of time, assuming that no fiber breakage occurs during the operation period of time. The fiber length of the actual cake and that of the ideal cake are equal because the drawing rate and winding time are the same for the actual cake and the ideal cake. The evaluation was made on the following five-point scale, in which “3” or a higher score indicates that the forming workability was acceptable or better.

5: The above ratio was 70% or more.

4: The above ratio was 60% or more and less than 70%.

3: The above ratio was 50% or more and less than 60%.

2: The above ratio was 40% or more and less than 50%.

1: The above ratio was less than 40%.

[Average Fiber Diameter (Average Filament Diameter) of Glass Fibers: μm]

The average fiber diameter of the glass fibers was evaluated in the following manner. From the obtained glass cloth were cut out two 30-cm-square pieces, one of which was used for observation of warp yarns, and the other of which was used for observation of weft yarns. Each of the two pieces was embedded in an epoxy resin (available from Marumoto Struers K.K. under the product name “3091”), and this resin was cured. Next, each of the cured products was polished enough to allow observation of warp yarns or weft yarns, and the polished surface was observed with a scanning electron microscope (SEM; available from JEOL Ltd. under the product name “JSM-6390A”) at a magnification of 500 times. For both the warp yarns and the weft yarns, 20 yarns were randomly selected, and the diameters of all of the selected glass fibers were measured. The average of the measured diameters was calculated as the average fiber diameter of the glass fibers.

[Count: tex]

The count of the glass yarns was evaluated according to 7.1 of JIS R 3420: 2013.

[Strength: N/tex]

The strength of the glass yarns was evaluated in the following manner. The tensile strength of the obtained glass yarns was determined according to 7.4.3 of JIS R 3420: 2013 using a 13-mm-radius circular clamp at a testing speed of 250 mm/min and a span length of 250 mm. The tensile strength thus determined was then divided by the count of the glass yarns to calculate the strength (units: N/tex) of the glass yarns.

[Thickness of Glass Cloth: μm]

The thickness of the glass cloth was evaluated according to Method A of 7.10.1 of JIS R 3420: 2013.

[Mass of Glass Cloth: g/m²]

The mass of the glass cloth was evaluated according to 7.2 of JIS R 3420: 2013.

[Density of Glass Cloth: Number of Glass Fibers Per Unit Length (25 mm)]

The density (weave density) of the glass cloth was evaluated according to 7.9 of JIS R 3420: 2013 for both the warp yarns and weft yarns.

[Appearance of Glass Cloth]

The appearance of the glass cloth was evaluated by visual inspection according to the following criteria. “Good” and “Excellent” indicate that the appearance was acceptable or better.

Excellent: The glass yarns were free of stripe patterns due to kinks caused by recesses between fingers, and the appearance of the glass cloth was perfectly acceptable for use in printed boards.

Good: The glass yarns showed slight stripe patterns due to kinks caused by recesses between fingers; however, the appearance of the glass cloth was sufficiently acceptable for use in printed boards.

Poor: The glass yarns showed stripe patterns due to kinks caused by recesses between fingers, and the appearance of the glass cloth was slightly unacceptable for use in printed boards.

Unacceptable: The glass yarns showed many stripe patterns due to kinks caused by recesses between fingers, and the appearance of the glass cloth was totally unacceptable for use in printed boards.

[Degree of Fiber Opening of Glass Cloth]

The degree of fiber opening of the glass cloth was evaluated by the air permeability (units: cm³/(cm²·sec)) of the glass cloth as determined according to 7.13 of JIS R 3420: 2013. A lower air permeability indicates that the degree of fiber opening of the glass cloth was higher.

TABLE 3

| | | | | Comparative |
|---|---|---|---|---|
| | | Example 12 | Example 13 | Example 7 |
| Glass fiber | Forming | 3 | 3 | 1 |
| | workability | | | |
| Glass yarn | Average fiber | 4.1 | 4.1 | 4.1 |
| | diameter (μm) | | | |
| | Number of | 50 | 50 | 50 |
| | filament fibers | | | |
| | Count (tex) | 1.7 | 1.7 | 1.7 |
| | Strength (N/tex) | 0.7 | 0.6 | 0.6 |
| Glass | Thickness (μm) | 15 | 15 | 15 |
| cloth | Mass (g/m²) | 12.7 | 12.7 | 12.7 |
| | Warp density | 95 | 95 | 95 |
| | Weft density | 95 | 95 | 95 |
| | Appearance | Excellent | Excellent | Excellent |
| | Air permeability | 110 | 110 | 110 |
| | (cm³/(cm² · sec)) | | | |

As seen from Table 3, the forming workability of the glass fibers was better in Examples 12 and 13 than in Comparative Example 7.

The present invention may be embodied in other forms without departing from the spirit or essential characteristics thereof. The embodiments disclosed in this specification are to be considered in all respects as illustrative and not limiting. The scope of the present invention is indicated by the appended claims rather than by the foregoing description, and all changes which come within the meaning and range of equivalency of the claims are intended to be embraced therein.

### INDUSTRIAL APPLICABILITY

The glass composition of the present invention can be used for production of glass fibers such as those for printed boards. The glass composition of the present invention can be used also for production of a shaped glass material such as glass flakes. The glass flakes can be used, for example, as an inorganic filler for printed boards.

1. A glass composition comprising, in wt %:
50≤SiO₂≤54;
25≤B₂O₃≤30;
12≤Al₂O₃≤15;
0.5≤MgO≤1.9;
3.0≤CaO≤5.5;
0≤ZnO≤3.5;
0.1≤Li₂O≤0.5; and
0.1≤Na₂O≤0.3,
the glass composition having a permittivity of less than 5.0 at a frequency of 1 MHz.

2. The glass composition according to claim 1, comprising, in wt %, 25≤B₂O₃≤28.

3. The glass composition according to claim 1, comprising, in wt %, 0.5≤MgO≤1.5.

4. The glass composition according to claim 1, comprising, in wt %:
25≤B₂O₃≤28; and
0.5≤MgO≤1.5.

5. The glass composition according to claim 1, comprising, in wt %:
25≤B₂O₃≤27; and
14≤Al₂O₃≤15.

6. The glass composition according to claim 1, comprising, in wt %, 25≤B₂O₃≤26.6.

7. The glass composition according to claim 1, comprising, in wt %, 50≤SiO₂≤52.5.

8. The glass composition according to claim 1, comprising, in wt %, 0.5≤MgO≤1.3.

9. The glass composition according to claim 1, comprising, in wt %, 0.5≤MgO≤1.0.

10. The glass composition according to claim 1, comprising, in wt %:
1.2≤MgO≤1.5; and
0.4≤Li₂O+Na₂O≤0.8.

11. The glass composition according to claim 1, comprising, in wt %, 1.5≤ZnO≤3.5.

12. The glass composition according to claim 1, being substantially free of ZnO and comprising, in wt %, 1.2≤MgO≤1.9.

13. The glass composition according to claim 10, wherein the total content of MgO and CaO is 5.5 wt % or more.

14. The glass composition according to claim 1, consisting essentially of, in wt %:
50≤SiO₂≤54;
25≤B₂O₃≤30;
12≤Al₂O₃≤15;
0.5≤MgO≤1.9;
3.0≤CaO≤5.5;
0≤ZnO≤3.5;
0.1≤Li₂O≤0.5; and
0.1≤Na₂O≤0.3.

15. The glass composition according to claim 1, used for glass fibers.

16. The glass composition according to claim 1, used for glass fibers having an average fiber diameter of 3 to 6 μm.

17. Glass fibers comprising the glass composition according to claim 1.

18. The glass fibers according to claim 17, having an average fiber diameter of 3 to 6 μm.

19. The glass fibers according to claim 17, having an average fiber diameter of 3 to 4.3 μm.

20. The glass fibers according to claim 17, having a strength of 0.4 N/tex or more.

21. A glass cloth comprising the glass fibers according to claim 17.

22. The glass cloth according to claim 21, having a thickness of 10 to 20 μm.

23. A method for producing glass fibers, comprising melting the glass composition according to claim 1 at a temperature of 1400° C. or higher, wherein glass fibers having an average fiber diameter of 3 to 6 μm are obtained.
